(19) United States
(12) Patent Application Publication
(10) Pub. No.: US 2024/0322475 A1
(43) Pub. Date: Sep. 26, 2024

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kazuaki HAMADA, Osaka (JP); Liping KANG, Mie (JP)

(21) Appl. No.: 18/600,110

(22) Filed: Mar. 8, 2024

(30) Foreign Application Priority Data
Mar. 22, 2023 (JP) 2023-045107

(51) Int. Cl. H01R 13/17; H01R 13/193; H01R 24/44

(52) U.S. Cl. CPC H01R 13/17; H01R 13/193; H01R 24/44

(57) ABSTRACT

A shield connector A includes an inner conductor 20 shaped such that a resiliently displaceable locking spring 24 projects from an outer peripheral surface of a body portion 21 having an axial direction oriented in a front-rear direction, and a dielectric 30 for retaining and accommodating the inner conductor 20 inserted from behind. The dielectric 30 includes an accommodation chamber 31 for accommodating the body portion 21, a locking portion 36 for retaining the inner conductor 20 by being locked to the locking spring 24, and an escaping groove 37 formed by recessing only a region facing the locking spring 24 in a circumferential direction, out of an inner peripheral surface of the accommodation chamber 31.

### CROSS-REFERENCE TO RELATED APPLICATIONS

This application is based on and claims priority from Japanese Patent Application No. 2023-045107, filed on Mar. 22, 2023, with the Japan Patent Office, the disclosure of which is incorporated herein in its entirety by reference.

### TECHNICAL FIELD

The present disclosure relates to a shield connector.

### BACKGROUND

Japanese Patent Laid-open Publication No. 2011-124136 discloses a coaxial connector provided with an inner conductor terminal fixed to a core wire of a coaxial cable, a dielectric for surrounding the inner conductor terminal and an outer conductor terminal for surrounding the dielectric. The inner conductor terminal inserted into a center hole of the dielectric is held in a retained state by locking a locking piece of the inner conductor terminal into a locking hole of the dielectric.

### SUMMARY

In the process of inserting the inner conductor terminal into the center hole of the dielectric, the locking piece slides in contact with the inner peripheral surface of the center hole while being resiliently deformed. Thus, insertion resistance increases. As a countermeasure against this, it is considered to enlarge an inner diameter of a region from an insertion opening of the center hole for the inner conductor terminal to a position near the locking hole. By doing so, the locking piece slides in contact with the center hole in the insertion process of the inner conductor terminal to generate sliding resistance only in a final stage of the insertion process. Thus, workability at the time of insertion is improved. However, if the inner diameter of the center hole is enlarged, a volume of an air layer in the center hole increases, wherefore a characteristic impedance locally increases and impedance matching is reduced.

A shield connector of the present disclosure was completed on the basis of the above situation and aims to combine a reduction in insertion resistance in inserting an inner conductor into a dielectric and suppression of a reduction in impedance matching.

The present disclosure is directed to a shield connector with an inner conductor shaped such that a resiliently displaceable locking spring projects from an outer peripheral surface of a body portion having an axial direction oriented in a front-rear direction, and a dielectric for retaining and accommodating the inner conductor inserted from behind, the dielectric including an accommodation chamber for accommodating the body portion, a locking portion for retaining the inner conductor by being locked to the locking spring, and an escaping groove formed by recessing only a region facing the locking spring in a circumferential direction, out of an inner peripheral surface of the accommodation chamber.

According to the present disclosure, it is possible to combine a reduction in insertion resistance in inserting an inner conductor into a dielectric and suppression of a reduction in impedance matching.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shield connector of a first embodiment.

FIG. 2 is an exploded perspective view of the shield connector shown in FIG. 1.

FIG. 3 is an enlarged perspective view of an inner conductor shown in FIG. 2.

FIG. 4 is a partial enlarged plan view in section of the shield connector shown in FIG. 1.

FIG. 5 is a partial enlarged plan view in section showing a state where locking springs are in escaping grooves in the process of inserting the inner conductor into a dielectric in the shield connector of the first embodiment.

FIG. 6 is a partial enlarged side view in section of the shield connector shown in FIG. 1.

FIG. 7 is a partial enlarged side view in section showing a state where the inner conductor is pulled out from the dielectric in the shield connector of the first embodiment.

FIG. 8 is a section along X-X of FIG. 7.

FIG. 9 is a section along X-X of the shield connector of the first embodiment showing the process of inserting the inner conductor into the dielectric.

FIG. 10 is a side view in section of a shield connector of a second embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described. Arbitrary combinations of a plurality of embodiments described below within a non-contradictory range are also included in embodiments of the invention.

(1) The shield connector of the present disclosure is provided with an inner conductor shaped such that a resiliently displaceable locking spring projects from an outer peripheral surface of a body portion having an axial direction oriented in a front-rear direction, and a dielectric for retaining and accommodating the inner conductor inserted from behind, the dielectric including an accommodation chamber for accommodating the body portion, a locking portion for retaining the inner conductor by being locked to the locking spring, and an escaping groove formed by recessing only a region facing the locking spring in a circumferential direction, out of an inner peripheral surface of the accommodation chamber. According to the configuration of the present disclosure, in inserting the inner conductor into the dielectric, the locking spring passes in the escaping groove, whereby sliding resistance between the locking spring and the dielectric is reduced or the generation of sliding resistance is avoided. Thus, insertion resistance in inserting the inner conductor can be reduced. Since the escaping groove, in which the locking spring passes, is shaped by recessing only the region facing the locking spring in the circumferential direction, impedance mismatch can be suppressed as compared to the case where an inner diameter is enlarged over an entire circumference.

(2) Preferably, the locking spring has a cantilever shape extending obliquely rearward from the outer peripheral surface of the body portion, an inner surface of the escaping groove includes a pair of inner side surfaces facing each other in the circumferential direction, and the pair of inner side surface are so inclined that a facing interval in the circumferential direction becomes narrower with distance from a center of the accommodation chamber in a radial direction in a back view of the dielectric. According to this configuration, a positional deviation in the circumferential direction of the inner conductor with respect to the dielectric is corrected by the sliding contact of the locking spring with the inner side surfaces of the escaping groove. Since the pair of inner side surfaces are so inclined that the facing interval in the circumferential direction becomes narrower with distance from the center of the accommodation chamber, a volume of an air layer in the escaping groove is suppressed to be small as compared to the case where the inner side surfaces are parallel to each other. In this way, an increase in characteristic impedance due to the formation of the escaping groove can be suppressed.

(3) Preferably in (1) or (2), a radial depth of the escaping groove is set such that the locking spring does not contact an inner surface of the escaping groove. According to this configuration, since the locking spring is not resiliently deformed in the process of inserting the body portion into the accommodation chamber, insertion resistance can be reduced.

(4) Preferably in (1) to (3), the inner conductor includes a stabilizer projecting from the outer peripheral surface of the body portion, and the dielectric is formed with a positioning groove, the stabilizer being fit into the positioning groove in the process of inserting the body portion into the accommodation chamber. According to this configuration, the locking spring can be guided into the escaping groove in pulling out the inner conductor rearward from the dielectric.

(5) Preferably in (4), the positioning groove is formed with a front stop portion for hindering a forward relative movement of the stabilizer with respect to the dielectric in a state where the locking spring is lockable to the locking portion. According to this configuration, the inner conductor can be positioned in the front-rear direction with respect to the dielectric by the locking action of the locking spring and the stabilizer.

### Details of Embodiments of Present Disclosure

### First Embodiment

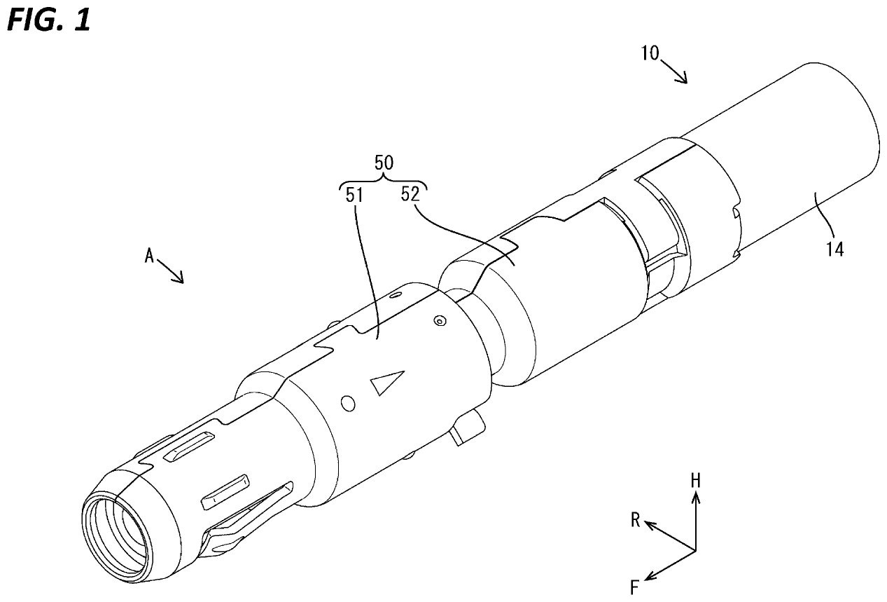

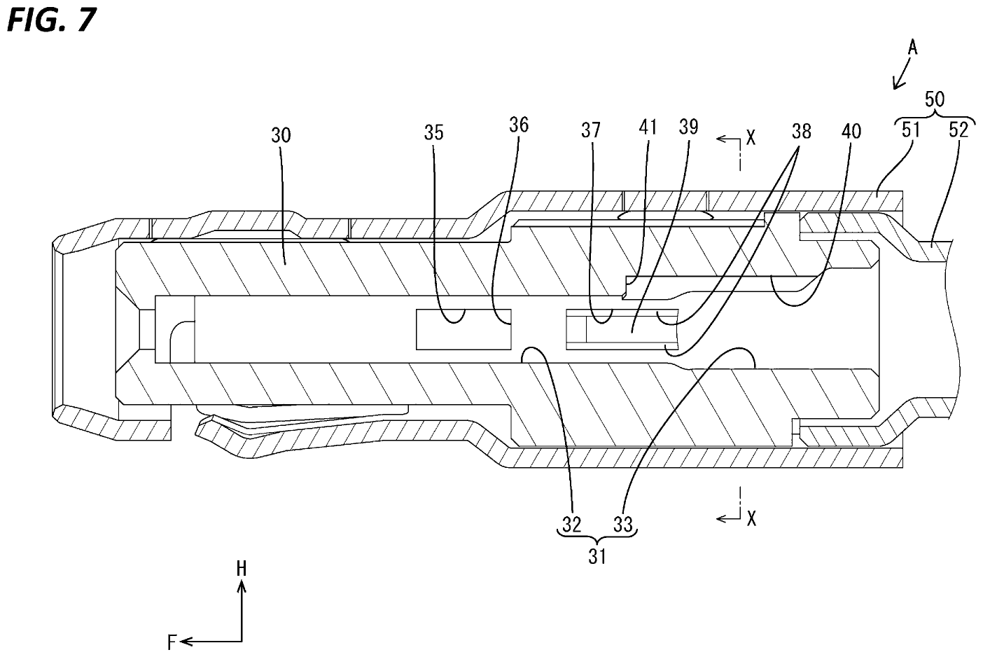

A shield connector A of a first specific embodiment of the present disclosure is described with reference to FIGS. 1 to 9. The present invention is not limited to these illustrations, but is represented by claims and intended to include all changes in the scope of claims and in the meaning and scope of equivalents. In the first embodiment, a direction F in FIGS. 1 to 7 is defined as a forward direction concerning a front-rear direction. A direction R in FIGS. 1 to 5, 8 and 9 is defined as a rightward direction concerning a lateral direction. A direction H in FIGS. 1 to 3 and 6 to 9 is defined as an upward direction concerning a vertical direction.

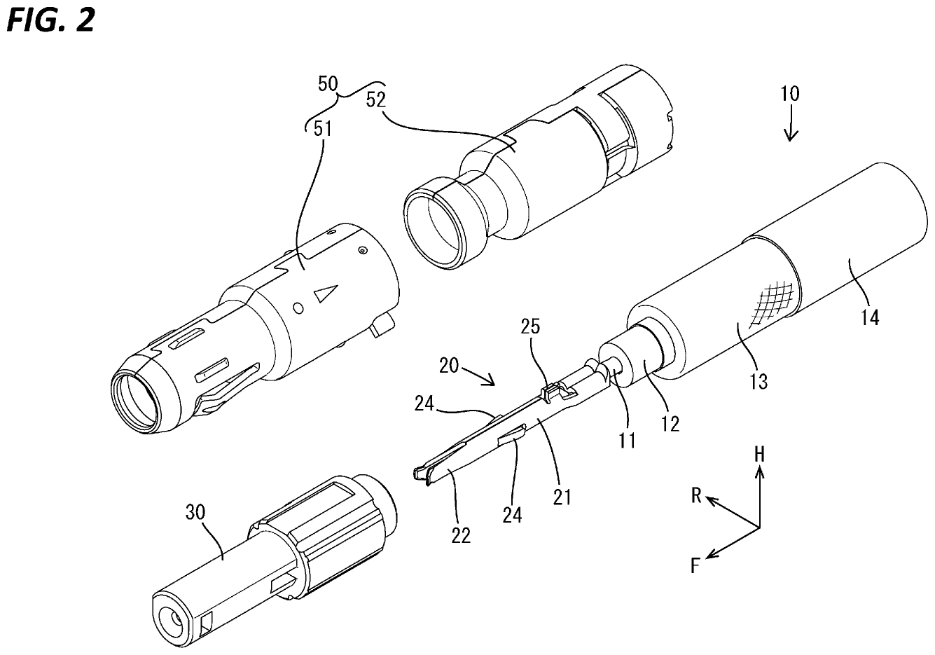

As shown in FIG. 1, the shield connector A of the first embodiment is a connector for communication connected to a front end part of a shielded cable 10 and having a shielding function. As shown in FIG. 2, the shielded cable 10 is a known conductive path in which one core wire 11 is surrounded by an insulation coating 12, the insulation coating 12 is surrounded by a braided wire 13, which is a shield member, and the braided wire 13 is surrounded by a sheath 14.

The shield connector A is provided with an inner conductor 20 fixed to the core wire 11, a dielectric 30 for accommodating the inner conductor 20 and an outer conductor 50 for surrounding the dielectric 30 and has a shape elongated in the front-rear direction as a whole. The outer conductor 50 is configured by fixing a front tubular member 51 and a rear tubular member 52 such that these tubular members 51, 52 are coaxial and continuous in the front-rear direction. A rear end part of the outer conductor 50 is connected to a front end part of the braided wire 13.

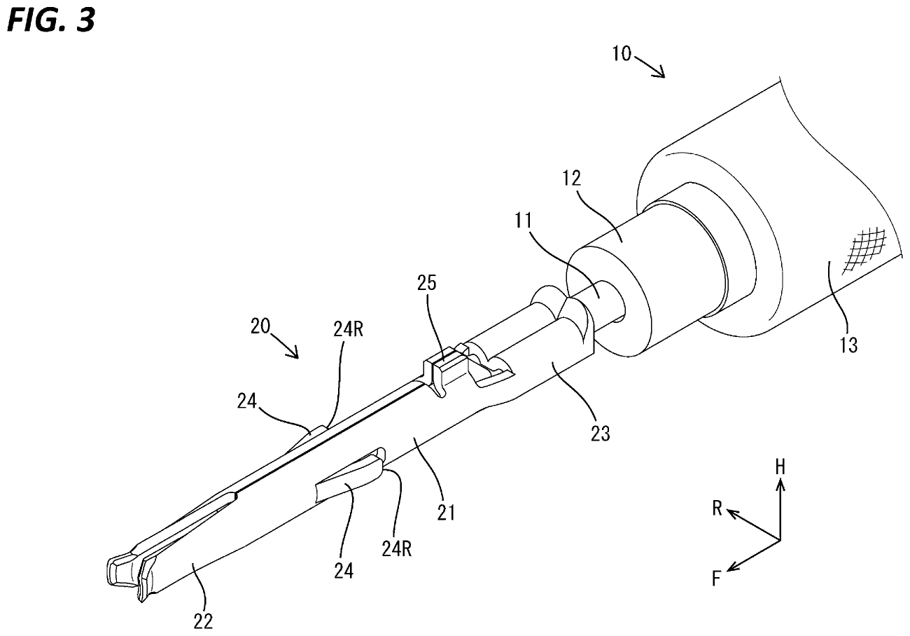

The inner conductor 20 is a single component formed into a shape elongated in the front-rear direction by applying bending and the like to a metal plate material. As shown in FIG. 3, the inner conductor 20 includes a tubular body portion 21, a halved connecting portion 22 extending forward from the body portion 21 and a crimping portion 23 extending rearward from the rear end of the body portion 21. The crimping portion 23 is fixed to a front end part of the core wire 11.

The body portion 21 is formed with a pair of locking springs 24 spaced apart in a circumferential direction. The locking spring 24 has a cantilever shape extending radially outward and obliquely rearward from the outer peripheral surface of the body portion 21. The locking spring 24 can be resiliently deformed in a radial direction with a front end part of the locking spring 24 as a fulcrum. A stabilizer 25 projecting radially outward is formed on the outer peripheral surface of the body portion 21. The stabilizer 25 is arranged behind rear ends 24R (extending ends) of the locking springs 24. The stabilizer 25 is located at a position separated by 90° from the pair of locking springs 24 in the circumferential direction.

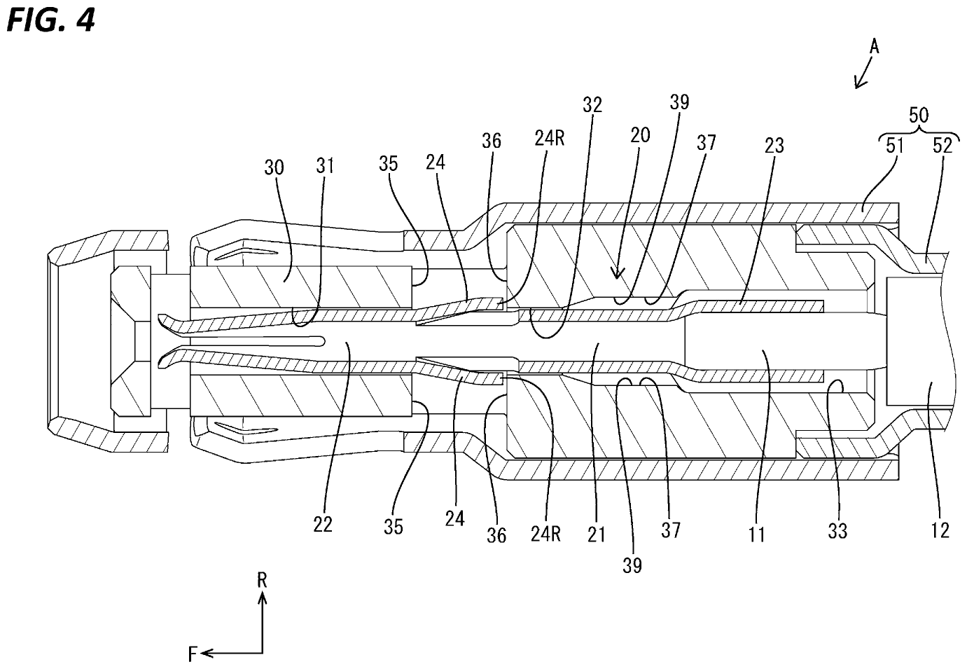

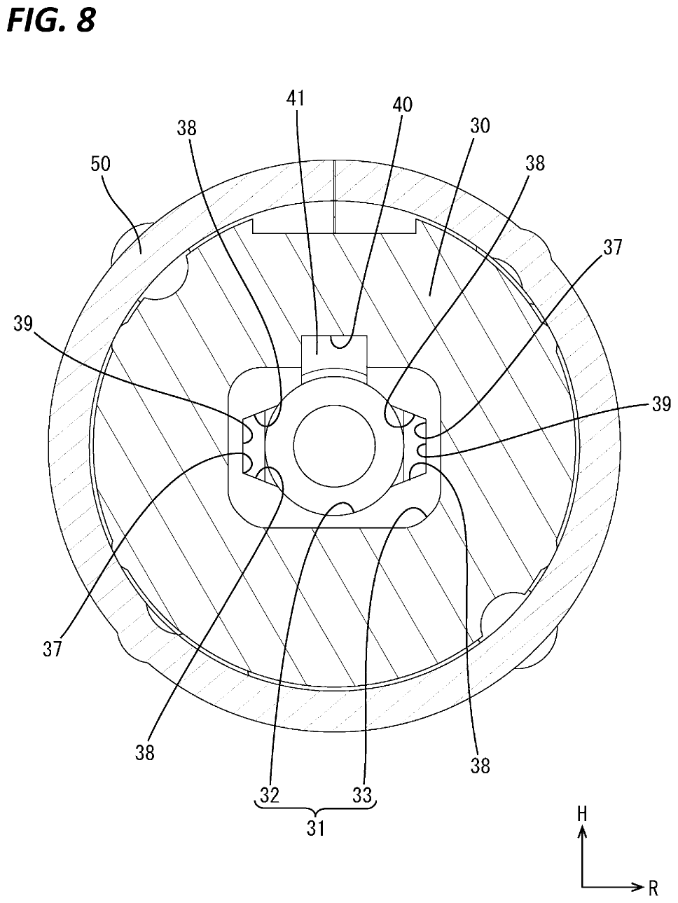

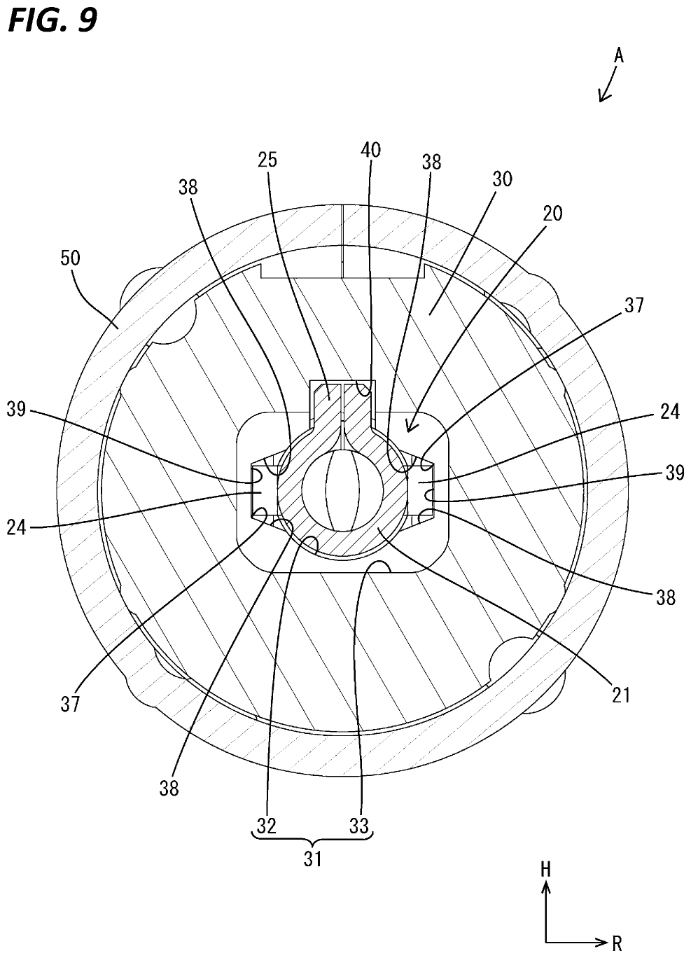

The dielectric 30 has a shape elongated in the front-rear direction as a whole. As shown in FIGS. 4 to 7, an elongated accommodation chamber 31 penetrating through the dielectric 30 in the front-rear direction is formed inside the dielectric 30. The inner conductor 20 is inserted into the accommodation chamber 31 from behind the dielectric 30. As shown in FIGS. 8 and 9, the accommodation chamber 31 is composed of a front space 32 having a circular cross-section and constituting a front end side region of the accommodation chamber 31 and a rear space 33 constituting a rear end side region of the accommodation chamber 31. A length in the front-rear direction of the front space 32 is longer than that of the rear space 33. In a back view of the dielectric 30, the rear space 33 has a rectangular shape. A height and a width of the rear space 33 are larger than an inner diameter of the front space 32.

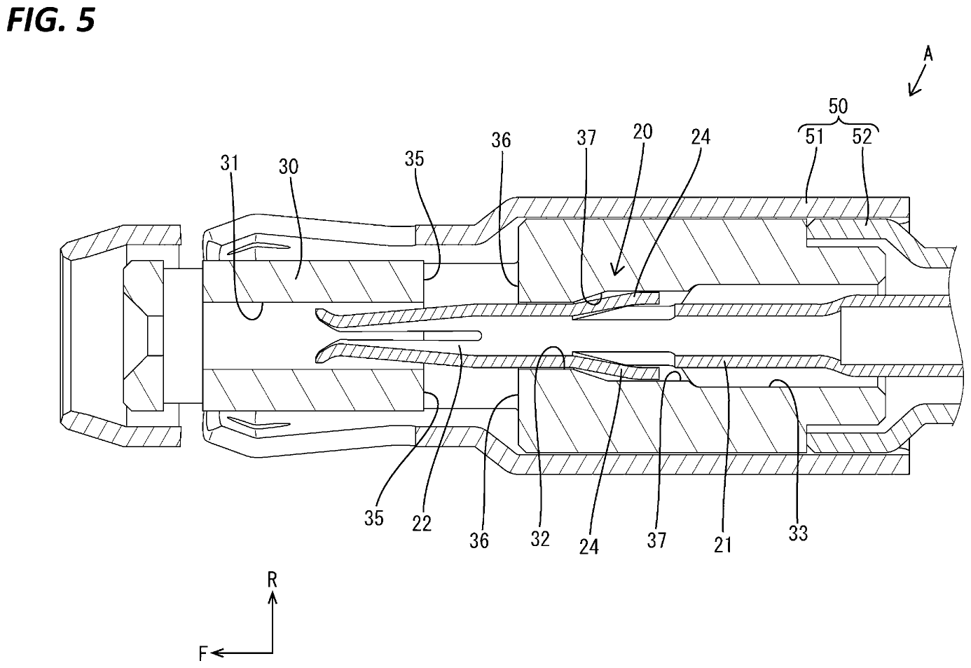

The inner diameter of the front space 32 is such a dimension that the body portion 21 is smoothly insertable into the front space 32, specifically a dimension slightly larger than an outer diameter of the body portion 21. As shown in FIGS. 4 and 5, the dielectric 30 is formed with a pair of locking spaces 35 spaced apart in the circumferential direction. The locking space 35 is a space penetrating from the inner peripheral surface of the front space 32 to the outer peripheral surface of the dielectric 30. Out of the inner wall surface of the locking space 35, a rear surface functions as a locking portion 36 for retaining the inner conductor 20. The rear end 24R of the locking spring 24 can be locked to the locking portion 36 from front.

As shown in FIGS. 4, 5 and 8, the dielectric 30 is formed with a pair of escaping grooves 37 spaced apart in the circumferential direction. In the front-rear direction, the pair of escaping grooves 37 are located behind the pair of locking spaces 35. In the circumferential direction, the pair of escaping grooves 37 are arranged at the same positions as the pair of locking spaces 35. The escaping groove 37 is elongated in the front-rear direction (direction parallel to an insertion direction of the inner conductor 20 into the dielectric 30). The rear end of the escaping groove 37 is open in the front wall of the rear space 33. As shown in FIGS. 8 and 9, the escaping groove 37 has a trapezoidal shape in a back view. Specifically, a facing interval between a pair of inner side surfaces 38 facing each other in the circumferential direction, out of the inner surface of the escaping groove 37, is gradually narrowed from a center (axial center) side of the accommodation chamber 31 toward a radially outer side.

Out of the inner surface of the escaping groove 37, a surface facing the center side of the accommodation chamber 31 is defined as a groove bottom surface 39. A circumferential width of the escaping groove 37 is smallest at the groove bottom surface 39. A circumferential width of the groove bottom surface 39 is slightly larger than a circumferential width of the locking spring 24. A depth of the escaping groove 37 is set to be larger than a radial projection dimension of the locking spring 24. That is, a radial dimension from the inner peripheral surface of the front space 32 to the groove bottom surface 39 is set to be larger than a radial dimension from the outer peripheral surface of the body portion 21 to the extending end (rear end 24R) of the locking spring 24.

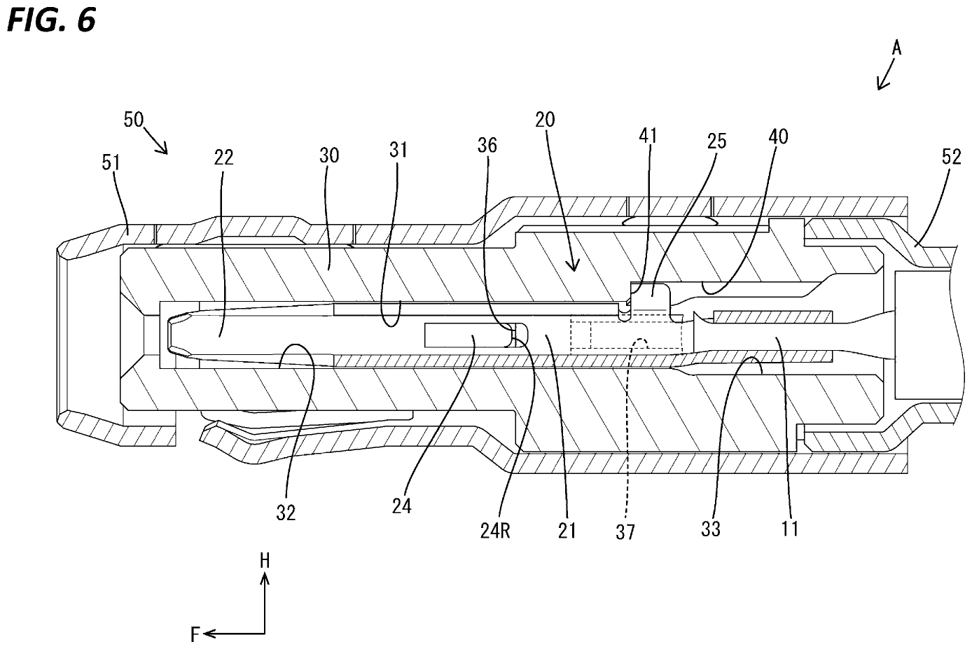

As shown in FIGS. 6 to 9, the dielectric 30 is formed with one positioning groove 40. The positioning groove 40 is shaped by recessing the inner peripheral surface of the rear space 33 and extends in the front-rear direction. The positioning groove 40 is located behind the escaping grooves 37. The front end of the positioning groove 40 is located at the front end of the rear space 33. In a back view, the stabilizer 25 is arranged at the same position as the positioning groove 40 when the pair of locking springs 24 are at the same positions as the pair of escaping grooves 37. A front end part of the positioning groove 40 is formed with a front stop portion 41, to which the stabilizer 25 can be locked from behind.

Next, functions and effects of the first embodiment are described. The inner conductor 20 is inserted into the accommodation chamber 31 from behind the dielectric 30. In an insertion process, the stabilizer 25 is fit into the positioning groove 40 and the pair of locking springs 24 are caused to enter the pair of escaping grooves 37. As shown in FIGS. 5 and 9, since the depths of the escaping grooves 37 are larger than the projection dimensions of the locking springs 24 in the radial direction, the locking springs 24 are not resiliently deformed while passing in the escaping grooves 37.

If the orientation of the inner conductor 20 slightly deviates with respect to the dielectric 30 in the circumferential direction when the locking springs 24 enter the escaping grooves 37, the locking springs 24 come into contact with the rear end edges of the inner side surfaces 38 of the escaping grooves 37, whereby a positional deviation is corrected. In particular, the locking spring 24 has a cantilever shape extending obliquely rearward from the outer peripheral surface of the body portion 21. The pair of inner side surfaces 38 are so inclined that the facing interval in the circumferential direction therebetween becomes narrower with distance from the center of the accommodation chamber 31. In this way, as the inner conductor 20 is inserted into the accommodation chamber 31, the locking springs 24 slide in contact with the inner side surfaces 38 from the center side of the accommodation chamber 31 toward the radially outer side, whereby a positional deviation of the inner conductor 20 is corrected.

In a final stage of the insertion process of the inner conductor 20, the locking springs 24 are resiliently deformed by contacting the front ends of the escaping grooves 37, out of the inner peripheral surface of the front space 32. Since the resiliently deformed locking springs 24 slide in contact with the inner peripheral surface of the front space 32 in regions between the front ends of the escaping grooves 37 and the locking portions 36, sliding resistance is generated between the locking springs 24 and the inner peripheral surface of the front space 32. Therefore, the insertion resistance is temporarily generated only in the final stage of the insertion process of the inner conductor 20.

If the inner conductor 20 is inserted to a proper assembly position, the locking springs 24 resiliently return to the radially outer side. In this way, as shown in FIG. 4, the rear ends 24R (extending ends) of the locking springs 24 enter the locking spaces 35 and are located to face the locking portions 36 from front and be lockable to the locking portions 36. Similarly, if the inner conductor 20 reaches the proper assembly position, the stabilizer 25 is located to face the front stop portion 41 from behind and be lockable to the front stop portion 41. In the above way, the assembly of the inner conductor 20 with the dielectric 30 is completed.

In pulling out the inner conductor 20 from the dielectric 30, the locking springs 24 are resiliently deformed radially inward by a jig (not shown) inserted into the locking spaces 35 from the outside of the dielectric 30. If the inner conductor 20 is pulled rearward by gripping the shielded cable 10 in this state, the rear ends 24R of the locking springs 24 are disengaged from the locking portions 36 and the inner conductor 20 starts to move rearward. Here, since the stabilizer 25 is fit in the positioning groove 40, the inner conductor 20 is not relatively displaced in the circumferential direction with respect to the dielectric 30. Therefore, the locking springs 24 can be reliably caused to enter the escaping grooves 37. While the pull-out of the inner conductor 20 is continued, the locking springs 24 continue to move in the escaping grooves 37. Thus, sliding resistance is not generated between the locking springs 24 and the dielectric 30.

The shield connector A of the first embodiment is provided with the inner conductor 20 and the dielectric 30. The inner conductor 20 is shaped such that the resiliently displaceable locking springs 24 project from the outer peripheral surface of the body portion 21 having an axial direction oriented in the front-rear direction. The dielectric 30 is a member for accommodating and retaining the inner conductor 20 inserted from behind. The dielectric 30 is formed with the accommodation chamber 31 for accommodating the body portion 21, the locking portions 36 and the escaping grooves 37. The locking portions 36 are parts for retaining the inner conductor 20 by being locked to the locking springs 24. The escaping grooves 37 are shaped by recessing only the regions facing the locking springs 24 in the circumferential direction, out of the inner peripheral surface of the accommodation chamber 31. That is, the escaping grooves 37 are shaped by recessing regions radially facing the locking springs 24 on the inner peripheral surface of the accommodation chamber 31. Further, the escaping grooves 37 are shaped by recessing only regions where the locking springs 24 pass in the process of inserting the inner conductor 20 into the dielectric 30.

According to this configuration, in inserting the inner conductor 20 into the dielectric 30, the locking springs 24 pass in the escaping grooves 37. The radial depths of the escaping grooves 37 are set such that the locking springs 24 do not contact the inner surfaces (groove bottom surfaces 39) of the escaping grooves 37. Since the locking springs 24 are not resiliently deformed in the process of inserting the body portion 21 into the accommodation chamber 31, the generation of insertion resistance can be avoided. In this way, insertion resistance in inserting the inner conductor 20 into the dielectric 30 can be reduced.

The escaping grooves 37 allowing the passage of the locking springs 24 are shaped by recessing only the regions facing the locking springs 24 in the circumferential direction, out of the inner peripheral surface of the accommodation chamber 31 (front space 32). Thus, as compared to the case where the inner diameter of the inner peripheral surface of the accommodation chamber 31 is enlarged over the entire circumference, a volume in the accommodation chamber 31, i.e. a volume of an air layer, is suppressed to a minimum level. Therefore, according to the shield connector A of the first embodiment, impedance mismatch due to a large secured volume of the air layer can be suppressed.

The locking spring 24 has a cantilever shape extending obliquely rearward from the outer peripheral surface of the body portion 21. The inner surface of the escaping groove 37 includes the pair of inner side surfaces 38 facing each other in the circumferential direction. In a back view of the dielectric 30, the pair of inner side surfaces 38 are so inclined that the facing interval in the circumferential direction becomes narrower with distance from the center of the accommodation chamber 31 in the radial direction. A positional deviation in the circumferential direction of the inner conductor 20 with respect to the dielectric 30 is corrected by the sliding contact of the locking springs 24 with the inner side surfaces 38 of the escaping grooves 37. Since the pair of inner side surfaces 38 are so inclined that the facing interval in the circumferential direction becomes narrower with outward distance from the center of the accommodation chamber 31 in the radial direction, a volume in the escaping groove 37 (volume of an air layer) is suppressed to be small as compared to the case where the inner side surfaces 38 are parallel to each other. In this way, an increase in characteristic impedance due to the formation of the escaping grooves 37 can be suppressed.

The inner conductor 20 includes the stabilizer 25 projecting from the outer peripheral surface of the body portion 21. The dielectric 30 is formed with the positioning groove 40, into which the stabilizer 25 is fit in the process of inserting the body portion 21 into the accommodation chamber 31. According to this configuration, the locking springs 24 can be reliably guided into the escaping grooves 37 in pulling out the inner conductor 20 rearward from the dielectric 30.

The positioning groove 40 of the dielectric 30 is formed with the front stop portion 41 for hindering a forward relative movement of the stabilizer 25 with respect to the dielectric 30 in a state where the locking springs 24 are lockable to the locking portions 36 (state where the inner conductor 20 is properly inserted in the dielectric 30). According to this configuration, the inner conductor 20 can be positioned in the front-rear direction with respect to the dielectric 30 by the locking action of the locking springs 24 and the stabilizer 25.

### Second Embodiment

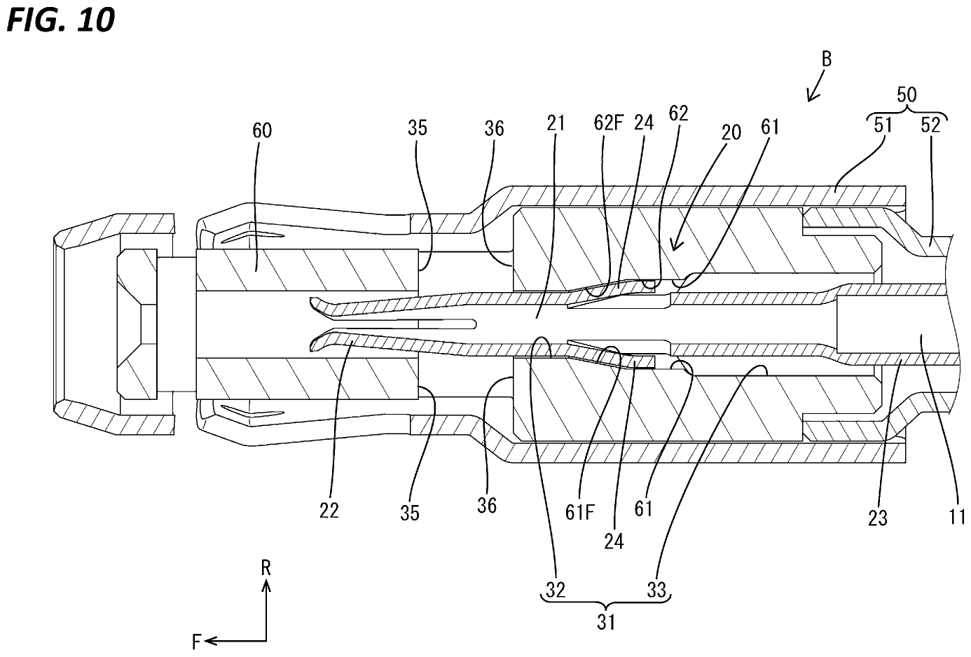

A second specific embodiment of the present disclosure is described with reference to FIG. 10. A shield connector B of the second embodiment differs from the first embodiment in the shape of escaping grooves 61 of a dielectric 60. Since the other components are the same as in the first embodiment, the same components are denoted by the same reference signs and the structures, functions and effects thereof are not described.

A front end part 61F of the escaping groove 61 of the second embodiment is shaped such that a radial depth of the escaping groove 61 becomes gradually shallower toward the front. That is, in a cross-section of the dielectric 60 cut to include an axis of an accommodation chamber 31, a front end part 62F of a groove bottom surface 62 is inclined in the same direction as a locking spring 24 and at the same angle as the locking spring 24 in a state not resiliently deformed. According to this configuration, since a volume of an air layer in the front end part 61F of the escaping groove 61 is less than in the first embodiment, characteristic impedance matching is improved.

### Other Embodiments

The present invention is not limited to the above described and illustrated embodiments, but is represented by claims. The present invention includes all changes in the scope of claims and in the meaning and scope of equivalents and includes also the following embodiments.

In the first and second embodiments, the pair of inner side surfaces of the escaping groove may be parallel to each other.

In the first and second embodiments, the radial depth of the escaping groove may be set such that the locking spring contacts the inner surface of the escaping groove.

In the first and second embodiments, the inner conductor may not include the stabilizer.

In the first and second embodiments, the dielectric may not include the front stop portion.

In the first and second embodiments, the stabilizer may be fit into the positioning groove before the locking springs enter the escaping grooves in the process of inserting the body portion into the accommodation chamber. By doing so, in the process of inserting the body portion into the accommodation chamber, the locking springs can be positioned at positions corresponding to the escaping grooves by fitting the stabilizer into the positioning groove.

In the second embodiment, the groove bottom surface of the escaping groove may be a surface inclined at a constant angle over an entire length from the front end to the rear end of the escaping groove.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield connector, comprising:
an inner conductor shaped such that a resiliently displaceable locking spring projects from an outer peripheral surface of a body portion having an axial direction oriented in a front-rear direction; and
a dielectric for retaining and accommodating the inner conductor inserted from behind,
the dielectric including:
an accommodation chamber for accommodating the body portion;
a locking portion for retaining the inner conductor by being locked to the locking spring, and
an escaping groove formed by recessing only a region facing the locking spring in a circumferential direction, out of an inner peripheral surface of the accommodation chamber.

2. The shield connector of claim 1, wherein:
the locking spring has a cantilever shape extending obliquely rearward from the outer peripheral surface of the body portion,
an inner surface of the escaping groove includes a pair of inner side surfaces facing each other in the circumferential direction, and
the pair of inner side surface are so inclined that a facing interval in the circumferential direction becomes narrower with distance from a center of the accommodation chamber in a radial direction in a back view of the dielectric.

3. The shield connector of claim 1, wherein a radial depth of the escaping groove is set such that the locking spring does not contact an inner surface of the escaping groove.

4. The shield connector of claim 1, wherein:
the inner conductor includes a stabilizer projecting from the outer peripheral surface of the body portion, and
the dielectric is formed with a positioning groove, the stabilizer being fit into the positioning groove in the process of inserting the body portion into the accommodation chamber.

5. The shield connector of claim 4, wherein the positioning groove is formed with a front stop portion for hindering a forward relative movement of the stabilizer with respect to the dielectric in a state where the locking spring is lockable to the locking portion.
